(19) United States
(12) Patent Application Publication
(10) Pub. No.: US 2017/0034347 A1
(43) Pub. Date: Feb. 2, 2017

(54) METHOD AND DEVICE FOR STATE NOTIFICATION AND COMPUTER-READABLE STORAGE MEDIUM

(71) Applicant: Xiaomi Inc., Beijing (CN)

(72) Inventors: Shen LI, Beijing (CN); Dayu SUN, Beijing (CN); Chao CHEN, Beijing (CN)

(73) Assignee: Xiaomi Inc.

(21) Appl. No.: 15/156,817

(22) Filed: May 17, 2016

(30) Foreign Application Priority Data
Jul. 27, 2015 (CN) 201510447091.8

(51) Int. Cl. H04M 3/42; H04M 1/725

(52) U.S. Cl. CPC H04M 3/42374; H04M 1/72566; H04M 3/42093; H04M 3/42017; H04B 2001/3861

(57) ABSTRACT

The present disclosure relates to a method and device for state notification and computer-readable storage medium. The method for state notification includes acquiring current state information about a user of a terminal and notifying a predetermined contact of the user of the current state information.

### CROSS-REFERENCE TO RELATED APPLICATIONS

This application is based upon and claims priority to Chinese Patent Application No. 201510447091.8, filed on Jul. 27, 2015, the entire contents of which are incorporated herein by reference.

### TECHNICAL FIELD

The present disclosure generally relates to the field of wireless communication technology, and more particularly, to a method and device for state notification and a computer-readable storage medium.

### BACKGROUND

Currently, when a user is in a meeting, in a class, in sleep, and so on, it is inconvenient for the user to answer a telephone call or reply to a message and to notify the caller of the current state of the user, which easily results in difficult communication.

### SUMMARY

Embodiments of the present disclosure provide a method and device for state notification and computer-readable storage medium. The technical solutions are as follows.

According to a first aspect of the present disclosure, there is provided a method for state notification. The method includes acquiring current state information about a user of a terminal. The method also includes notifying a predetermined contact of the user of the current state information.

According to a second aspect of the present disclosure, there is provided a device for state notification. The device includes a memory configured to store instructions. The device also includes a processor configured to execute the instructions to perform a method that includes acquiring current state information about a user of a terminal and notifying a predetermined contact of the user of the current state information.

According to a third aspect of the present disclosure, there is provided a non-transitory computer-readable storage medium having stored therein instructions that, when executed by a processor of a terminal, cause the terminal to perform a method for state notification. The method includes acquiring current state information about a user of the terminal. The method also includes notifying a predetermined contact of the user of the current state information.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart showing a method for state notification according to an exemplary embodiment.

FIG. 2 is a flowchart showing a method for acquiring current state information about a user of a terminal, according to an exemplary embodiment.

FIG. 3 is a flowchart showing a method for acquiring the current state information about a user of a terminal according to an exemplary embodiment.

FIG. 4 is a flowchart showing a method for acquiring the current state information about a user of a terminal according to an exemplary embodiment.

FIG. 5 is a flowchart showing a method for notifying a predetermined contact of the user of the current state information according to an exemplary embodiment.

FIG. 6 is a flowchart showing a method for generating a ring-back tone corresponding to the current state information about the user according to an exemplary embodiment.

FIG. 7 is a flowchart showing a method for generating a ring-back tone corresponding to the current state information about the user according to an exemplary embodiment.

FIG. 8 is a schematic diagram showing the current state of the user marked by a predetermined contact, according to an exemplary embodiment.

FIG. 9 is a block diagram showing a device for state notification according to an exemplary embodiment.

FIG. 10 is a block diagram showing an acquisition module according to an exemplary embodiment.

FIG. 11 is a block diagram showing an acquisition module according to an exemplary embodiment.

FIG. 12 is a block diagram showing an acquisition module according to an exemplary embodiment.

FIG. 13 is a block diagram showing an acquisition module according to an exemplary embodiment.

FIG. 14 is a block diagram showing a notification module according to an exemplary embodiment.

FIG. 15 is a block diagram showing a notification module according to an exemplary embodiment.

FIG. 16 is a block diagram showing a device according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

The technical solutions provided by embodiments of the present disclosure relate to a terminal having communication capability. The terminal can notify a predetermined contact of current state of its user, such as in a meeting, in a class, in sleep, in exercise, in a flight, and so on, in which it is inconvenient for the user to answer a telephone can or to reply to a message, such that the predetermined contact receiving the current state of the user can determine Whether to contact the user based on the state of the user. The disclosed solutions can improve efficiency of communications between users and enhance user experience.

The terminal may be any suitable device having communication capability, such as a mobile phone, a computer, a digital broadcast terminal, a messaging device, a gaming console, a tablet, a medical device, exercise equipment, and a personal digital assistant.

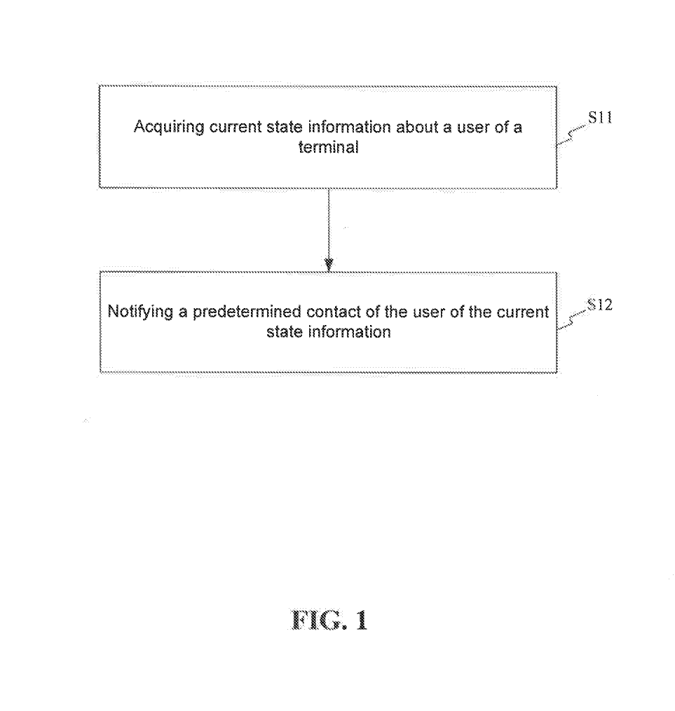

FIG. 1 is a flow chart showing a method for state notification according to an exemplary embodiment. As shown in FIG. 1, the method for state notification is used in a terminal, and may include the following steps.

In step S11, the current state information about a user of a terminal is acquired.

In step S12, a predetermined contact of the user is notified of the current state information.

In some situations, a user of the terminal may be in a state that is inconvenient for the user to answer a telephone call or to reply to a message. By notifying a predetermined contact of the user of the current state information about the user, the predetermined contact can know the reasons why the user did not answer the telephone call or did not reply to the message. Additionally or alternatively, the predetermined contact can acquire the current state of the user before contacting the user, such that the predetermined contact can determine whether to contact the user based on the current state of the user. As such, communications between users become smoother, communication efficiency can be improved, and user experience can be enhanced.

For acquiring the current state information about a user of a terminal in step S11, the following methods may be implemented, but the present disclosure is not limited to the following methods.

Method 1

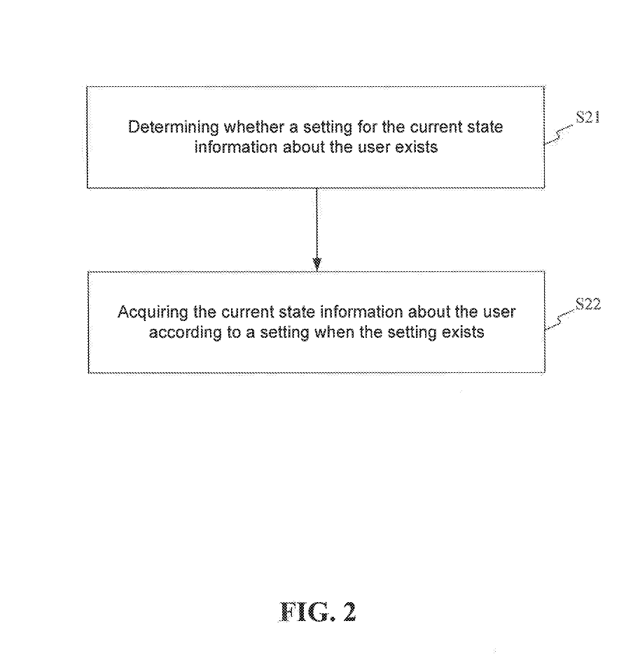

FIG. 2 is a flowchart showing a method for acquiring current state information about a user of a terminal according to an exemplary embodiment. As shown in FIG. 2, step S11 includes the following steps.

In step S21, it is determined whether a setting for the current state information about the user exists.

In step S22, the current state information about the user is acquired according to the setting when the setting exists.

In an alternative solution, the terminal may be provided with a function of setting user state, by which the user can manually set the current state of the user. If the terminal determines that the user has performed an operation of setting the current state, the terminal can acquire the current state information about the user according to the setting. By enabling the user to set the current state, a predetermined contact can be notified timely when the user is in a state that is inconvenient for the user to answer a telephone call or to reply to a message, thereby ensuring smooth communication between users and improving user experience.

Method 2

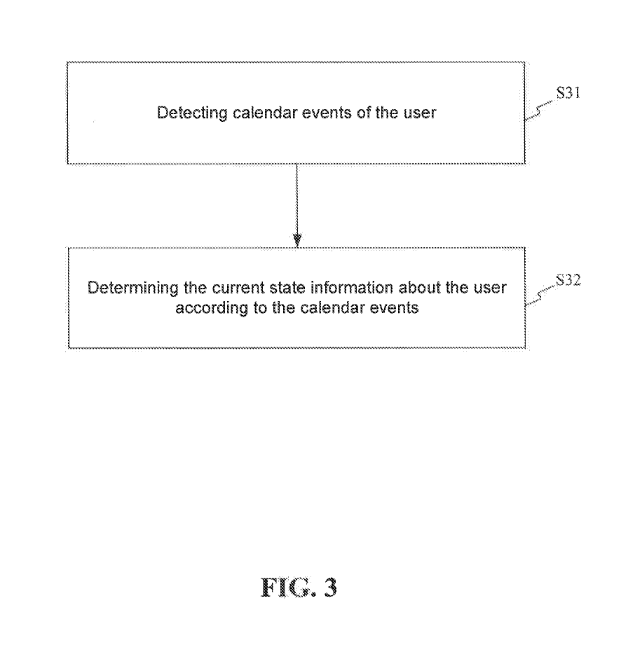

FIG. 3 is a flowchart showing a method for acquiring current state information about a user of a terminal according to an exemplary embodiment. As shown in FIG. 3, step S11 includes the following steps.

In step S31, calendar events of the user are detected.

In step S32, the current state information about the user is determined according to the calendar events.

For example, according to a calendar of the user indicating that the user will attend a meeting during 9:00-12:00 on Jul. 23, 2015, the terminal can determine that the state of the user during 9:00-12:00 on Jul. 23, 2015 is in a meeting. As another example, according to the calendar of the user indicating that the user will fly to Chengdu from Beijing during 10:00-12:40 on Jul. 24, 2015, the terminal can determine that the state of the user during 10:00-12:40 on Jul. 24, 2015 is in flight.

In exemplary embodiments, the current state of a user may be further determined based on calendar events, without requiring the user to manually set his/her own state. This can result in more flexible, convenient, prompt, and accurate acquisition of the current state of the user. When it is inconvenient for the user to answer a telephone call or to reply a message, the terminal can timely notify a predetermined contact of the current state of the user, thereby ensuring smooth communications between users and improving user experience.

Method 3

The step S11 may include: acquiring current state information about the user from an intelligent wearable device that is associated with (e.g., linked to) the terminal.

For example, the terminal can automatically change the current state information about the user to be in sleep when an intelligent wearable device notifies the terminal that the user is currently sleeping. Alternatively or additionally, the terminal can change the current state information about the user to be in exercise when an intelligent wearable device notifies the terminal that the user is currently running.

In exemplary embodiments, by detecting the current state of the user in real time using an intelligent wearable device, it is possible to acquire the current state more accurately. Thus, a predetermined contact can be notified timely when the user is in a state that is inconvenient for the user to answer a telephone call or to reply to a message. Accordingly, smooth communications between users can be ensured and user experience can be improved.

Method 4

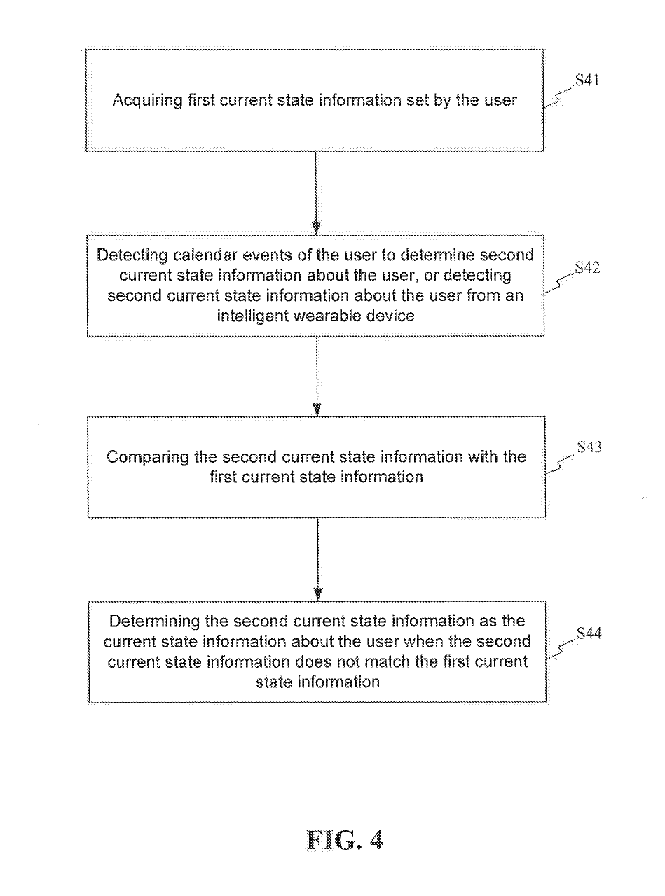

FIG. 4 is a flowchart showing a method for acquiring the current state information about a user of a terminal according to an exemplary embodiment. As shown in FIG. 4, step S11 may include the following steps.

In step S41, first current state information set by the user is acquired.

In step S42, calendar events of the user are detected to determine second current state information about the user, or second current state information about the user is detected or acquired from an intelligent wearable device.

In step S43, the second current state information is compared with the first current state information.

In step S44, the second current state information is determined as the current state information about the user when the second current state information does not match the first current state information.

Through the above described methods 1-3, the terminal can acquire at least two different states about the user. A priority may be set for preferably using the current state determined based on the calendar events or the current state detected by an intelligent wearable device. For example, the user may have set his/her state as normal for the period of 9:00-12:00 on Jul. 23, 2015, indicating that the user can answer a telephone call or reply to a message. The calendar events, however, indicate that the user will fly to Chengdu during 10:00-12:40 on Jul. 23, 2015. In such situations, the terminal can change the current state information about the user corresponding to the time period of 10:00-12:40 on Jul. 23, 2015 to be in flight. Alternatively or additionally, in a case where the state of the user is set as normal but the current state detected by an intelligent wearable device indicates that the user is in exercise, the terminal can automatically change the current state information about the user to be in exercise.

In exemplary embodiments, by selecting current state information from different current state information about the user acquired using different methods, more accurate current state of the user can be determined that better matches the actual state of the user. A predetermined contact can be timely notified when the user is in a state that is inconvenient for the user to answer a telephone call or to reply to a message, thereby ensuring smooth communications between users and improving user experience.

In some embodiments, a priority may be set for each of the current states of the user acquired by the above three methods. The priority indicates which method is preferable for determining the current state of the user when the current states of the user acquired by the three methods are different. For example, the highest priority may be set for the current state of the user detected by an intelligent wearable device (i.e., the third method), a medium priority may be set for the current state of the user determined based on calendar events (i.e., the second method), and the lowest priority may be set for the current state of the user manually set by the user (i.e., the first method). Alternatively or additionally, in step S12, notifying a predetermined contact of the user of the current state information may be implemented by, but not limited to, the following methods:

Method A

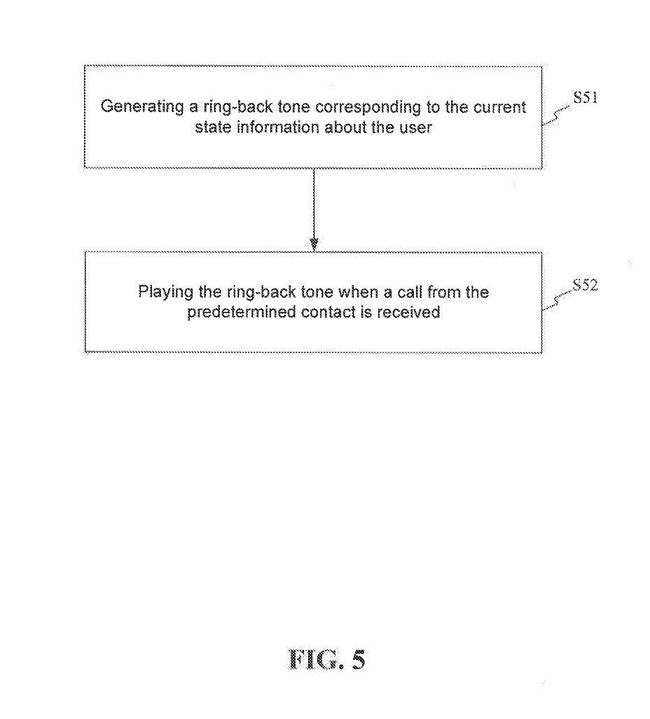

FIG. 5 is a flowchart showing a method for notifying the predetermined contact of the user of the current state information according to an exemplary embodiment. As shown in FIG. 5, step S12 includes the following steps.

In step S51, a ring-back tone corresponding to the current state information about the user is generated.

In step S52, the ring-back tone is played when a call from the predetermined contact is received.

In exemplary embodiments, the terminal of the user plays the ring-back tone corresponding to the current state of the user when receiving a call from the predetermined contact, such that the predetermined contact is notified of the current state of the user and reasons why the user cannot answer the call, by listening to the ring-back tone. This ensures smooth communications between users and improved user experience.

Alternatively or additionally, generating a ring-back tone corresponding to the current state information about the user in step S51 may be implemented by recording or selecting a default ring tone corresponding to the current state.

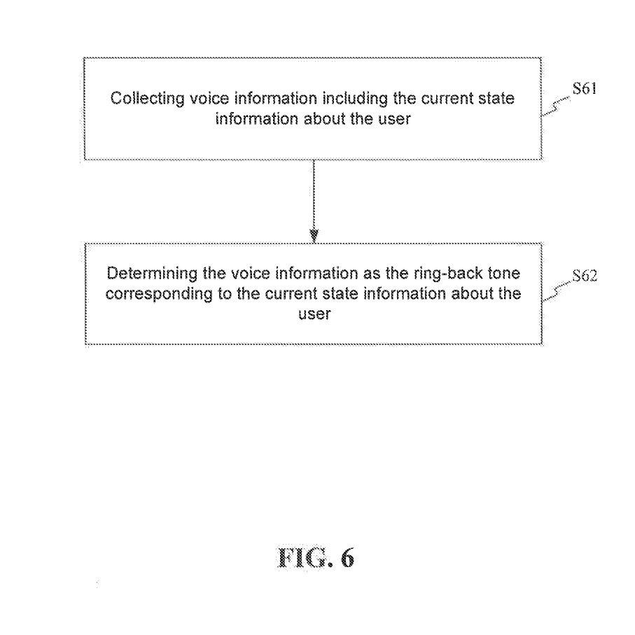

FIG. 6 is a flowchart showing a method for generating a ring-back tone corresponding to the current state information about the user according to an exemplary embodiment. As shown in FIG. 6, step S51 includes the following steps.

In step S61, voice information including the current state information about the user is collected.

In step S62, the voice information is determined as the ring-back tone corresponding to the current state information about the user.

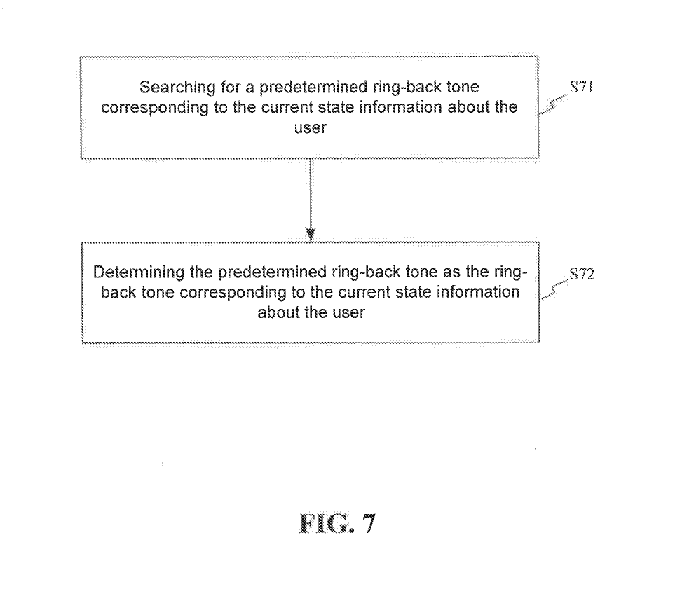

FIG. 7 is a flowchart showing a method for generating a ring-back tone corresponding to the current state information about the user according to an exemplary embodiment. As shown in FIG. 7, step S51 includes the following steps:

In step S71, a predetermined ring-back tone corresponding to the current state information about the user is searched for.

In step S72, the predetermined ring-back tone is determined as the ring-back tone corresponding to the current state information about the user.

In exemplary embodiments, the user can orally describe his/her own current state and record his/her voice description, and use the voice information acquired by recording as the ring-back tone corresponding to the current state information about the user. Alternatively or additionally, the user can select a default ring tone corresponding to the current state as the ring-back tone corresponding to the current state information about the user. As such, the predetermined contact knows the current state of the user upon listening to the ring-back tone and knows the reasons why the user cannot answer the call. This ensures smooth communications between users and improved user experience.

Method B

Alternatively or additionally, step S12 may include: transmitting the current state information to a terminal of the predetermined contact. The terminal of the predetermined contact marks the current state of the user according to the received current state information.

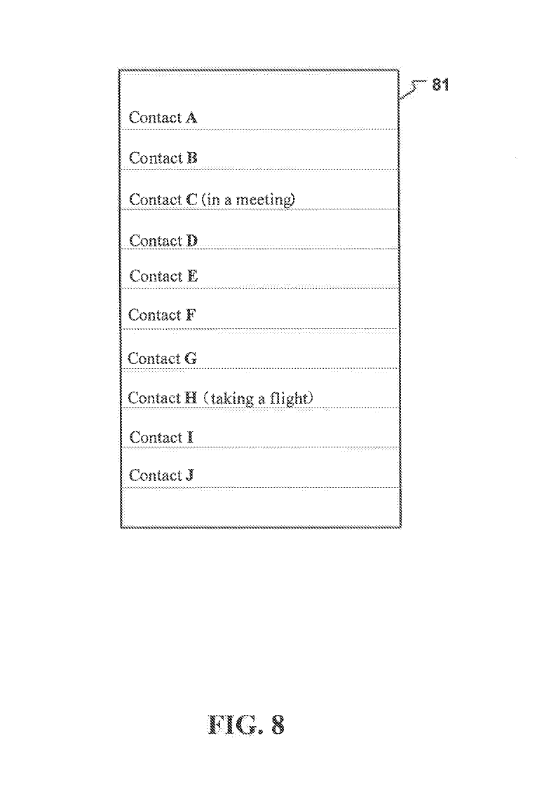

FIG. 8 is a schematic diagram showing the current state of the user marked by the predetermined contact according to an exemplary embodiment. As shown in FIG. 8, in a contact list 81 of the predetermined contact, a current state of every contact can be marked. If the current state is normal, it is not necessary to mark the current state.

In exemplary embodiments, a terminal of a user can push the current state information about the user to a terminal of a predetermined contact of the user, such that the terminal of the predetermined contact can mark the current state of the user at a location of the user in the contact list. The terminal can acquire the current state of the user before contacting the user and determine whether to contact the user based on the current state of the user. As such, communications between users become smoother, communication efficiency can be improved, and user experience can be enhanced.

The implementations of step S11 and step S12 are not limited to the above methods. A variety of implementations of step S11 and a variety of implementations of step S12 can be combined in any manner to achieve the technical solutions of the present disclosure.

The following are embodiments of a device of the present disclosure, which can be used to perform the methods of the present disclosure.

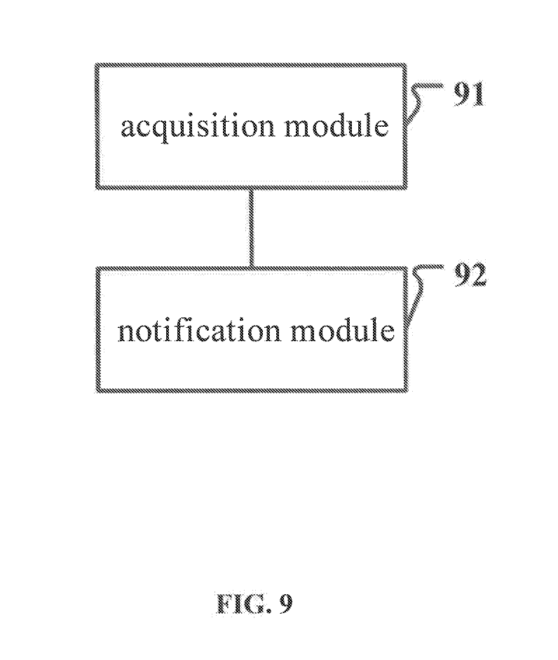

FIG. 9 is a block diagram showing a device for state notification according to an exemplary embodiment. The device may be implemented entirely or partially as an electrical device including hardware, software, or a combination thereof. As shown in FIG. 9, the device for state notification includes: an acquisition module 91 configured to acquire current state information about a user of a terminal, and a notification module 92 configured to notify a predetermined contact of the user of the current state information.

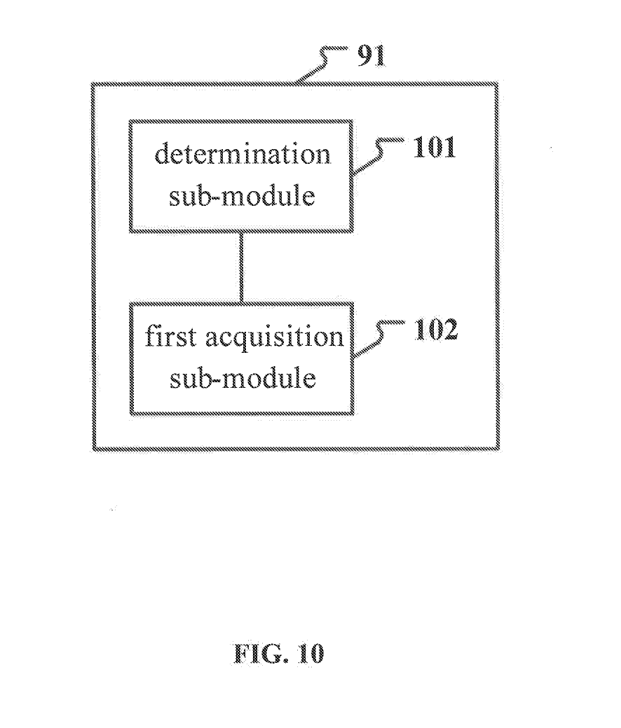

FIG. 10 is a block diagram showing an acquisition module according to an exemplary embodiment. As shown in FIG. 10, the acquisition module 91 may optionally include: a determination sub-module 101 configured to determine whether a setting for the current state information about the user exists, and a first acquisition sub-module 102 configured to acquire the current state information about the user according to the setting when the setting exists.

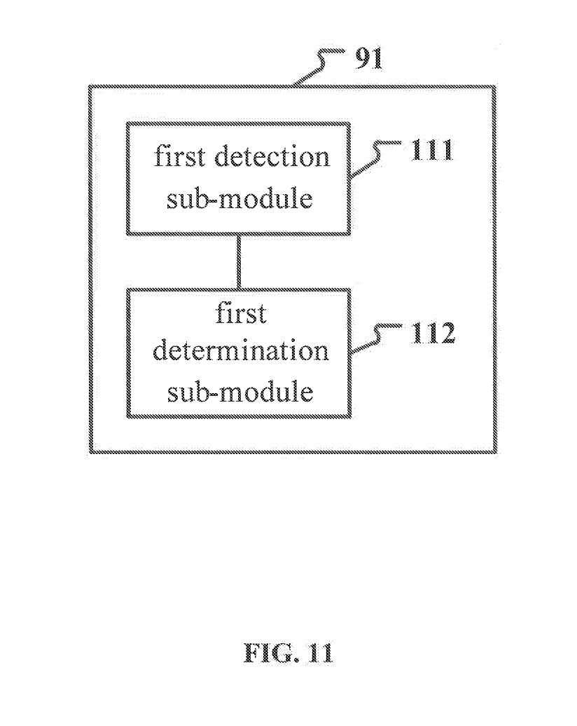

FIG. 11 is a block diagram showing an acquisition module according to an exemplary embodiment. As shown in FIG. 11, the acquisition module 91 may optionally include: a first detection sub-module 111 configured to detect calendar events of the user, and a first determination sub-module 112 configured to determine the current state information about the user based on the calendar events.

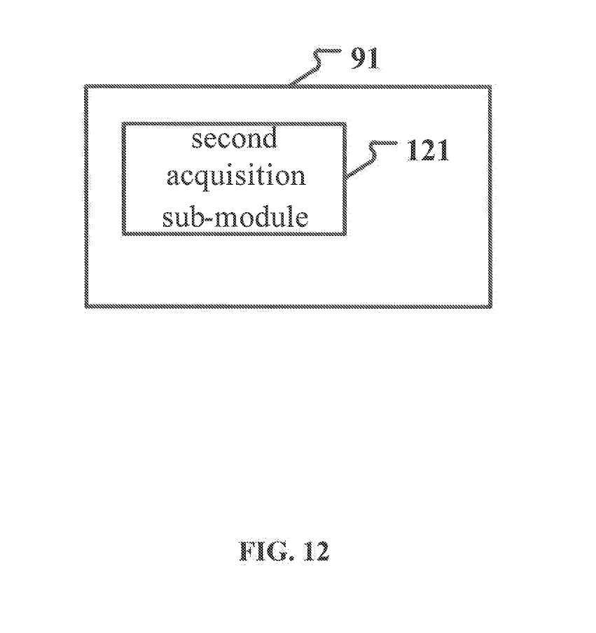

FIG. 12 is a block diagram showing an acquisition module according to an exemplary embodiment. As shown in FIG. 12, the acquisition module 91 may optionally include: a second acquisition sub-module 121 configured to acquire the current state information about the user from an intelligent wearable device that is associated with (e.g., linked to) the terminal.

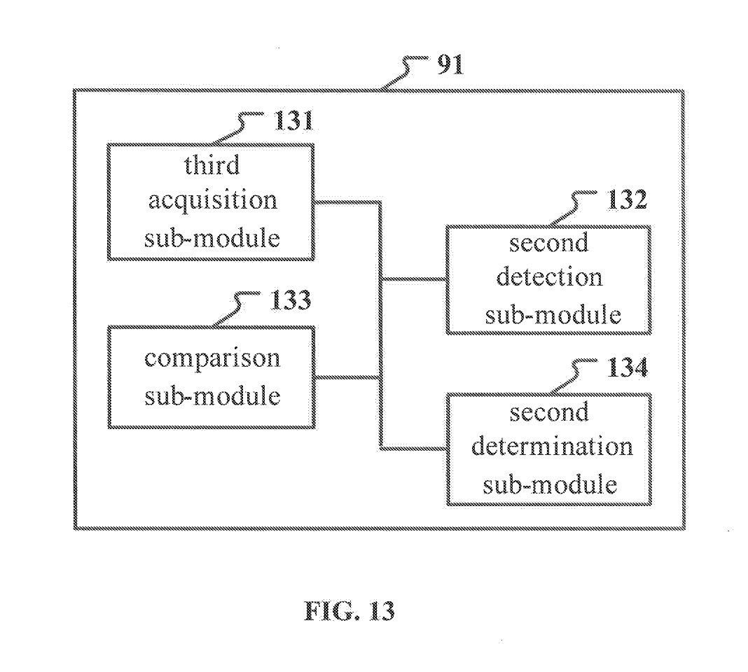

FIG. 13 is a block diagram showing an acquisition module according to an exemplary embodiment. As shown in FIG. 13, the acquisition module 91 may optionally include a third acquisition sub-module 131 configured to acquire first current state information set by the user. The acquisition module 91 may optionally include a second detection sub-module 132 configured to detect calendar events of the user to determine second current state information about the user, or to detect or acquire the second current state information about the user from an intelligent wearable device. The acquisition module 91 may optionally include a comparison sub-module 133 configured to compare the second current state information with the first current state information. The acquisition module 91 may optionally include a second determination sub-module 134 configured to determine the second current state information as the current state information about the user when the second current state information does not match the first current state information.

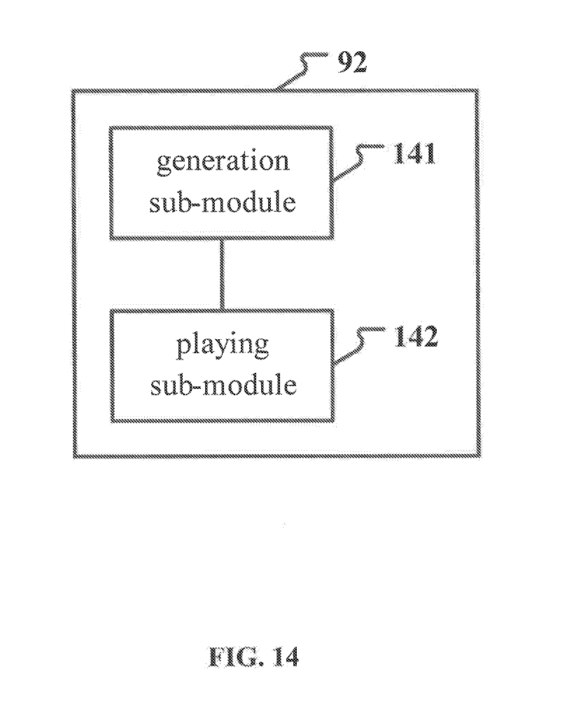

FIG. 14 is a block diagram showing a notification module according to an exemplary embodiment. As shown in FIG. 14, the notification module 92 may optionally include: a generation sub-module 141 configured to generate a ring-back tone corresponding to the current state information about the user, and a playing sub-module 142 configured to play the ring-back tone when a call from the predetermined contact is received.

Alternatively or additionally, the generation sub-module 141 is configured to collect voice information including current state information about the user and determine the voice information as the ring-back tone corresponding to the current state information about the user.

Alternatively or additionally, the generation sub-module 141 is configured to search for a predetermined ring-back tone corresponding to the current state information about the user and determine the predetermined ring-back tone as the ring-back tone corresponding to the current state information about the user.

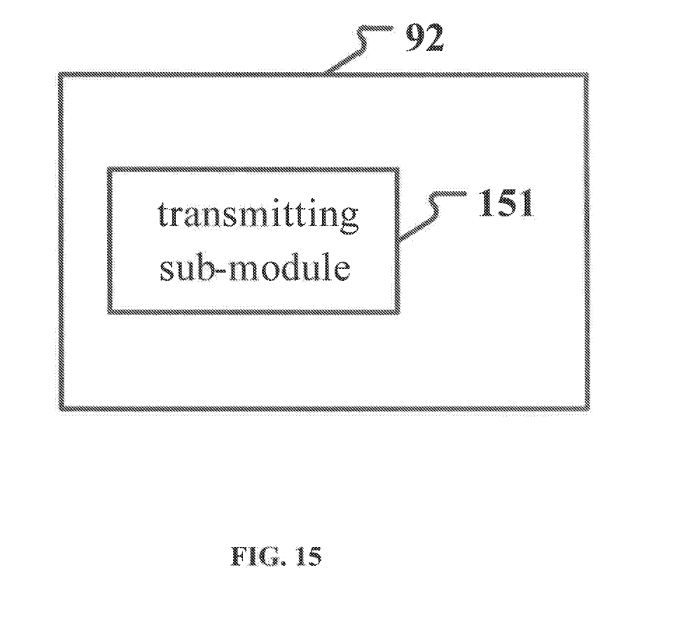

FIG. 15 is a block diagram showing a notification module according to an exemplary embodiment. As shown in FIG. 15, the notification module 92 may optionally include a transmitting sub-module 151 configured to transmit the current state information to a terminal of the predetermined contact, which marks the current state of the user according to the current state information.

According to a third aspect of embodiments of the present disclosure, there is provided a device for state notification. The device includes a processor and a memory for storing instructions executable by the processor. The processor is configured to acquire current state information about a user of a terminal, and notify a predetermined contact of the user of the current state information about the user.

With respect to the devices in the above embodiments, the specific manners for performing operations using individual modules included in the devices have been described in detail in the discussions relating to the methods. Therefore, descriptions of the manner for performing operations using individual modules included in the devices will not be repeated.

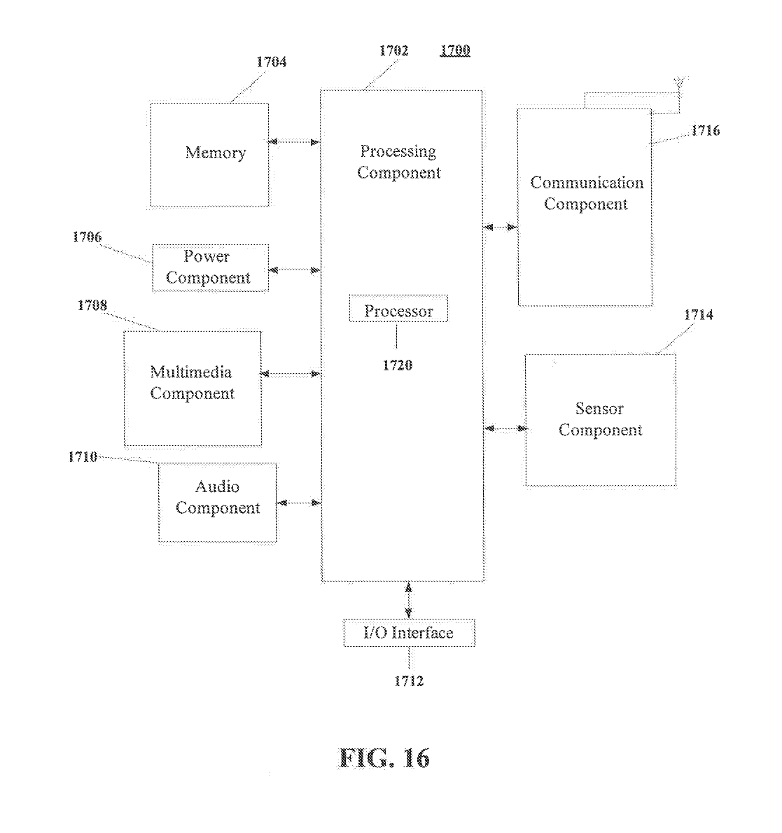

FIG. 16 is a block diagram showing a device 1700 according to an exemplary embodiment. The device 1700 may be included in a terminal device. For example, the device 1700 may be included in a video camera, a voice recording device, a mobile phone, a computer, a digital broadcast terminal, a messaging device, a gaming console, a tablet, a medical device, exercise equipment, a personal digital assistant, and the like.

The device 1700 may include one or more of the following components: a processing component 1702, a memory 1704, a power component 1706, a multimedia component 1708, an audio component 1710, an input/output (I/O) interface 1712, a sensor component 1714, and a communication component 1716.

The processing component 1702 controls overall operations of the device 1700, such as the operations associated with display, telephone calls, data communications, camera operations, and recording operations. The processing component 1702 includes one or more processors 1720 configured to execute instructions (e.g., instructions stored in the memory 1704) to perform all or part of the above described methods. In some embodiments, the processing component 1702 may include one or more modules configured to facilitate the interaction between the processing component 1702 and other components. For example, the processing component 1702 may include a multimedia module configured to facilitate the interaction between the multimedia component 1708 and the processing component 1702.

The memory 1704 is configured to store various types of data to support the operation of the device 1700. Examples of such data include instructions for any applications or methods implemented by the device 1700, contact data, phonebook data, messages, pictures, video, etc. The memory 1704 may be implemented as any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, and a magnetic or optical disk.

The power component 1706 provides electrical power to various components of the device 1700. The power component 1706 may include a power management system, one or more power sources, and other components associated with the powre generation, management, and distribution in the device 1700.

The multimedia component 1708 includes a screen providing an output interface between the device 1700 and the user. In some embodiments, the screen may include a liquid crystal display (LCD) and a touch panel (TP). In some embodiments, the screen includes a touch panel configured to receive input signals from the user. The touch panel may include one or more touch sensors configured to detect touches, swipes, and gestures on the touch panel. The touch sensors may not only detect a boundary of a touch or swipe action, but also detect a period of time and a pressure associated with the touch or the swipe action. In some embodiments, the multimedia component 1708 includes a front camera and/or a rear camera. When the device 1700 is in an operation mode, such as a photographing mode or a video mode, the front camera and/or the rear camera may receive or capture external multimedia data. Each of the front camera and the rear camera may be a fixed optical lens system or may have focus and optical zoom capability.

The audio component 1710 is configured to output and/or input audio signals. For example, the audio component 1710 includes a microphone configured to receive an external audio signal when the device 1700 is in an operation mode, such as a call mode, a recording mode, and a voice recognition mode. The received audio signal may be further stored in the memory 1704 or transmitted via the communication component 1716. In some embodiments, the audio component 1710 further includes a speaker configured to output audio signals.

The I/O interface 1712 provides an interface between the processing component 1702 and peripheral interface modules, such as a keyboard, a click wheel, buttons, and the like. The buttons may include, but are not limited to, a home button, a volume button, a starting button, and a locking button.

The sensor component 1714 includes one or more sensors configured to provide status assessments of various aspects of the device 1700. For instance, the sensor component 1714 may detect an open/closed status of the device 1700. The sensor component 1714 may detect relative positioning of components, e.g., the display and the keyboard, of the device 1700. The sensor component 1714 may detect a change in position of the device 1700 or a component of the device 1700. In some embodiments, the sensor component 1714 may detect at least one of presence or absence of user's contact with the device 1700, an orientation or an acceleration/deceleration of the device 1700, and a change in temperature of the device 1700. The sensor component 1714 may include a proximity sensor configured to detect the presence of nearby objects without any physical contact. The sensor component 1714 may also include a light sensor, such as a CMOS or CCD image sensor, for use in imaging applications. In some embodiments, the sensor component 1714 may also include an accelerometer sensor, a gyroscope sensor, a magnetic sensor, a pressure sensor, or a temperature sensor.

The communication component 1716 is configured to facilitate wired or wireless communication between the device 1700 and other devices. The device 1700 can access, via the communication component 1716, a wireless network cofigured based on a communication standard, such as WiFi, 2G, or 3G, 4G, or a combination thereof. In one exemplary embodiment, the communication component 1716 receives a broadcast signal or broadcast associated information from an external broadcast management system via a broadcast channel In one exemplary embodiment, the communication component 1716 further includes a near field communication (NFC) module configured to facilitate short-range communications For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, to perform the above described methods.

In exemplary embodiments, the present disclosure relates to a non-transitory computer-readable storage medium including instructions, such as the memory 1704 that stores the instructions. The instructions are executable by the processor 1720 of the device 1700 for performing the above-described methods. For example, the non-transitory computer-readable storage medium may be a ROM, a random access memory (RAM), a CD-ROM, a magnetic tape, a floppy disc, an optical data storage device, and the like.

In some embodiments, the present disclosure relates to a non-transitory computer-readable storage medium having stored therein instructions that, when executed by the processor of the device 1700, cause the device 1700 to perform the above described methods for state notification. The methods may include: acquiring current state information about a user of a terminal and notifying a predetermined contact of the user of the current state information.

In some embodiments, acquiring the current state information may include determining whether a setting for the current state information about the user exists, and acquiring the current state information about the user according to the setting when the setting exists.

In some embodiments, acquiring the current state information may include detecting calendar events of the user, and determining the current state information about the user based on the calendar events.

In some embodiments, acquiring the current state information may include acquiring the current state information about the user from an intelligent wearable device that is associated with (e.g., linked to) the terminal.

In some embodiments, acquiring the current state information may include acquiring first current state information set by the user; detecting calendar events of the user to determine second current state information about the user, or detecting second current state information about the user from an intelligent wearable device; comparing the second current state information with the first current state information; and determining the second current state information as the current state information about the user when the second current state information does not match the first current state information.

In some embodiments, notifying the current state information may include generating a ring-back tone corresponding to the current state information about the user, and playing the ring-back tone when a call from the predetermined contact is received.

In some embodiments, generating the ring-back tone may include collecting voice information including the current state information about the user, and determining the voice information as the ring-back tone corresponding to the current state information about the user.

In some embodiments, generating the ring-back tone may include searching for a predetermined ring-back tone corresponding to the current state information about the user, and determining the predetermined ring-back tone as the ring-back tone corresponding to the current state information about the user.

In some embodiments, notifying the current state information may include transmitting the current state information to a terminal of the predetermined contact which marks current state of the user according to the current state information.

Other embodiments of the invention will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and embodiments be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for state notification comprising:
acquiring current state information about a user of a terminal; and
notifying a predetermined contact of the user of the current state information.

2. The method of claim 1, wherein acquiring the current state information comprises:
determining whether a setting for the current state information about the user exists; and
acquiring the current state information about the user according to the setting when the setting exists.

3. The method of claim 1, wherein acquiring the current state information comprises:
detecting calendar events of the user; and
determining the current state information about the user based on the calendar events.

4. The method of claim 1, wherein acquiring the current state information comprises:
acquiring the current state information about the user from an intelligent wearable device that is associated with the terminal.

5. The method of claim 1, wherein acquiring the current state information comprises:
acquiring first current state information set by the user;
detecting calendar events of the user to determine second current state information about the user, or detecting the second current state information about the user from an intelligent wearable device;
comparing the second current state information with the first current state information; and
determining the second current state information as the current state information about the user when the second current state information does not match the first current state information.

6. The method of claim 1, wherein notifying the current state information comprises:
generating a ring-back tone corresponding to the current state information about the user; and
playing the ring-back tone when a call from the predetermined contact is received.

7. The method of claim 6, wherein generating the ring-back tone comprises:
collecting voice information including the current state information about the user; and
determining the voice information as the ring-back tone corresponding to the current state information about the user.

8. The method of claim 6, wherein generating the ring-back tone comprises:
searching for a predetermined ring-back tone corresponding to the current state information about the user; and
determining the predetermined ring-back tone as the ring-back tone corresponding to the current state information about the user.

9. The method of claim 1, wherein notifying the current state information comprises:
transmitting the current state information to a terminal of the predetermined contact that marks current state of the user according to the current state information.

10. A device for state notification, comprising:
a memory configured to store instructions; and
a processor configured to execute the instructions to perform a method comprising:
acquiring current state information about a user of a terminal; and
notifying a predetermined contact of the user of the current state information.

11. The device of claim 10, wherein acquiring the current state information comprises:
determining whether a setting for the current state information about the user exists; and
acquiring the current state information about the user according to the setting when the setting exists.

12. The device of claim 10, wherein acquiring the current state information comprises:
detecting calendar events of the user; and
determining the current state information about the user according to the calendar events.

13. The device of claim 10, wherein acquiring the current state information comprises:
acquiring the current state information about the user from an intelligent wearable device that is associated with the terminal.

14. The device of claim 10, wherein acquiring the current state information comprises:
acquiring first current state information set by the user;
detecting calendar events of the user to determine second current state information about the user, or detecting the second current state information about the user from an intelligent wearable device;
comparing the second current state information with the first current state information; and
determining the second current state information as the current state information about the user when the second current state information does not match the first current state information.

15. The device of claim 10, wherein notifying the current state information comprises:
generating a ring-back tone corresponding to the current state information about the user; and
playing the ring-back tone when a call from the predetermined contact is received.

16. The device of claim 15, wherein generating the ring-back tone comprises:
collecting voice information including current state information about the user and determining the voice information as the ring-back tone corresponding to the current state information about the user.

17. The device of claim 15, wherein generating the ring-back tone comprises:
searching for a predetermined ring-back tone corresponding to the current state information about the user and determining the predetermined ring-back tone as the ring-back tone corresponding to the current state information about the user.

18. The device of claim 10, wherein notifying the current state information comprises:
transmitting the current state information to a terminal of the predetermined contact that marks current state of the user according to the current state information.

19. A non-transitory computer-readable storage medium having stored therein instructions that, when executed by a processor of a terminal, cause the terminal to perform a method for state notification, the method comprising:
acquiring current state information about a user of the terminal; and
notifying a predetermined contact of the user of the current state information.
